(19) United States
(12) Patent Application Publication
(10) Pub. No.: US 2011/0033568 A1
(43) Pub. Date: Feb. 10, 2011

(54) DEVICE FOR PRODUCTION OF NANOFIBRES THROUGH ELECTROSTATIC SPINNING OF POLYMER MATRIX

(76) Inventors: Ladislav Sevcik, Liberac (CZ); Jan Cmelik, Liberac (CZ); Radek Sladecek, Knezmost (CZ)

Correspondence Address: OSTROLENK FABER GERB & SOFFEN, 1180 AVENUE OF THE AMERICAS, NEW YORK, NY, 100368403, US

(21) Appl. No.: 12/936,527

(22) PCT Filed: Apr. 3, 2009
(86) PCT No.: PCT/CZ2009/000047

§ 371 Date: Oct. 6, 2010

(30) Foreign Application Priority Data
Apr. 9, 2008 (CZ) PV2008-219

(51) Int. Cl. D01D 5/00; B82Y 40/00

(52) U.S. Cl. 425/169; 425/174.8 E; 977/788

(57) ABSTRACT

The principle of the present disclosure is the device for production of nanofibres through electrostatic spinning of polymer matrix in a spinning space, in which against each other there is positioned a collecting electrode and a spinning electrode, between which an electric field of high intensity is induced. Next to this, in the spinning space there is arranged at least one electrical device which is coupled with winding of a transformer (8, 11), which is insulated for high voltage, while the second winding of transformer (8, 11) is connected to the device for generating and/or evaluating of electric voltage pulses positioned outside the spinning space.

### TECHNICAL FIELD

The invention relates to a device for production of nanofibres through electrostatic spinning of polymer matrix in a spinning space, in which against each other there is positioned a collecting electrode and a spinning electrode, between which an electric field of high intensity is induced, in which at least one electrical device is arranged.

### BACKGROUND ART

The disadvantage of all to date known devices for production of nanofibres through electrostatic spinning of liquid matrices is, that into the electrostatic spinning field induced by a difference of electric potential of the spinning and the collecting electrode, especially thanks to induction of high voltage, it is impossible to place any electric devices and to energize such devices. This in principle excludes the possibility to monitor some important parameters of the electrostatic spinning field, polymer matrix, conditions in the spinning space, and thus also any active intervention into these parameters.

The CZ PV 2006-361 discloses the device enabling monitoring of parameters of polymer matrix, at which is chemical distribution system, in which the polymer matrix is prepared and/or stored, galvanic separated from the spinning chamber, in which this matrix is subjected to spinning. In the area between the chemical distribution system and the spinning chamber there is created a guidance, on which in a displaceable manner there is mounted a tank, which serves for transfer of batches of polymer matrix from the chemical distribution system into the spinning chamber and vice-versa. Such arrangement enables monitoring of parameters of polymer matrix and their active modification in the chemical distribution system, nevertheless only before the polymer matrix is brought into the spinning space and before its spinning. Next disadvantages lieespecially in usage of relatively large quantity of further relatively complicated elements, like for example systems for pumping of the polymer matrix into the tank and from the tank, and in a long time delay between the active intervention into the parameters of polymer matrix in chemical distribution system and its reaction during electrostatic spinning. Moreover, at usage of this device, only the parameters of polymer matrix may be monitored, not the conditions in the spinning space, which exercise nearly the same impact upon the process of the electrostatic spinning. To the most important parameters belong especially electrical conditions in the spinning space, which result primarily from humidity, temperature and composition of atmosphere in it, while monitoring of these values in combination with their modification substantially increases effectiveness of the process of electrostatic spinning as well as its safety, as it may prevent inflammation or even explosion of vapours of solvent of polymer matrix contained in the spinning space.

The goal of the invention is to enable positioning in principle of any electrical devices, such as measuring, evaluating and lighting elements, possibly also of mechanical elements with a drive enabling active intervention into some parameters of the spinning space.

### PRINCIPLE OF THE INVENTION

The goal of the invention has been achieved by a device for production of nanofibres through electrostatic spinning of polymer matrix in a spinning space, in which against each other there is positioned a collecting electrode and a spinning electrode, between which an electric field of high intensity is induced, in which at least one electrical device is arranged, whose principle consists in that, the electrical device is connected to winding of a transformer, which is insulated for high voltage, while the second winding of the transformer is connected to the device for generating and/or evaluating of electric voltage pulses, which is positioned outside the spinning space.

The most advantageous manner for bringing the electric voltage pulses, that serve as a source of energy for electrical device or as controlling signals for its activity, is through a transformer, when the electrical device is in the spinning space connected to the primary winding of the transformer, which is insulated for high voltage, while the secondary winding of transformer is connected to source of alternating voltage positioned outside the spinning space. By this a supplying of electric voltage pulses into electrical device in the spinning space is ensured, and simultaneously conducting-away of high direct voltage induced on electrical device outside the spinning space or even into the source of alternating voltage is being prevented.

In the same manner, outside the spinning space also the outputs of these electrical devices in a form of electric voltage pulses may be conducted away. In such a case the electrical device is further connected to primary winding of the output transformer, whose secondary winding is connected to data device positioned outside the spinning space. The data device serves in this case for processing and/or modifying and/or storage and/or displaying of outputs of the electrical device.

The source of alternating voltage for operation of electric device is with advantage, especially thanks to its availability, the common public distribution network.

Electrical device, which can be positioned into the spinning space upon utilisation of principle of the invention, is nearly any electrical device, for example a illuminating element to improve visibility in the spinning space. Another advantageous device is also a measuring element for example for determining the parameters of polymer matrix or composition of atmosphere in the spinning space, whose utilisation substantially increases safety of the whole device, as it may predict and in combination with further electrical devices even prevent the danger of inflammation of vapours of a solvent or their explosion.

To evaluate the data of measuring device there is further positioned an evaluation element in the spinning space.

A similar electrical device, that moreover further processes the obtained or evaluated information and possibly even controls activity of further electrical devices positioned in the spinning space or outside it, is the controlling system, which either comprises a processor or other logic circuit on basis of relays or transistors, etc.

Another electrical element, whose positioning in the spinning space is advantageous from the point of view of modifying the conditions in it, or parameters of polymer matrix, is for example the drive of mechanical element, which actively influences these conditions or parameters.

Next to this, the electric energy brought into the spinning space may be further utilised for indirect increasing of temperature in the spinning space or of some elements positioned in it, what in some cases facilitates or ever enables electrostatic spinning of some types of polymer matrices. The electrical device positioned in the spinning space in such a case is at least one heat resistor.

### DESCRIPTION OF THE DRAWING

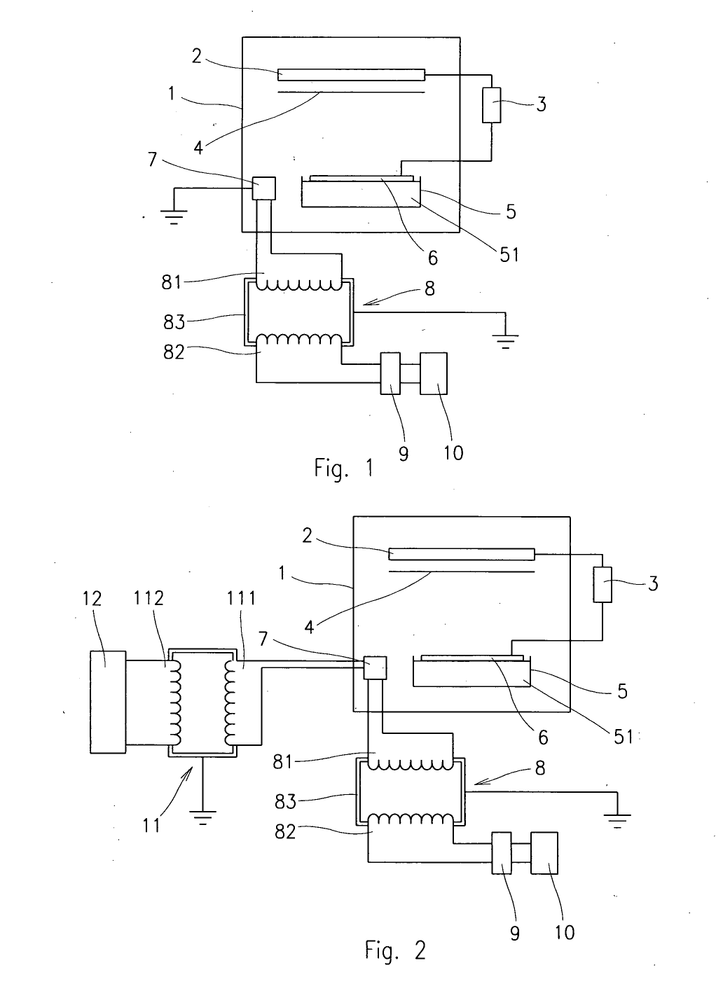

Two variants of device for production of nanofibres through electrostatic spinning of polymer matrix according to the invention are schematically represented in the enclosed drawing, where the FIG. 1 shows cross-section of the device for production of nanofibres through electrostatic spinning of liquid matrices, in whose spinning space the electrical device is positioned, and the FIG. 2 shows cross-section of the device for production of nanofibres through electrostatic spinning of liquid matrices, in whose spinning space the electrical device is positioned, which is further connected with the data device positioned outside the spinning space.

### EXAMPLES OF EMBODIMENT

The device for production of nanofibres through electrostatic spinning of liquid matrices according to the invention and its principle will be described on example of embodiment schematically represented in the FIG. 1. To increase the lucidity and simplicity of this picture, some elements of the device are shown only in a simplified manner regardless their real structure or proportions, while other elements, that are not essential for understanding the principle of the invention and whose structure or mutual arrangement are obvious to person skilled in the art are not represented at all.

The device for electrostatic spinning of polymer matrix comprises the spinning chamber 1 defining the spinning space, in whose upper section there is arranged the collecting electrode 2, which is connected to one pole of source 3 of high direct voltage positioned outside the spinning chamber 1. The represented collecting electrode 2 is formed of a metal plate, nevertheless in further not represented examples of embodiment may be according to technological requirements or space possibilities used any other known structure of collecting electrode 2, possibly several collecting electrodes 2 of any type, or their combination.

In the space under the collecting electrode 2 there is by known means created the not represented guidance of substrate 4, which serves for depositing of a layer of nanofibres and its consequent carrying outside the spinning space. In the represented example of embodiment is as a substrate 4 used an electrically non-conductive fabric, nevertheless the concrete type of the used substrate 4, manner of its movement through the spinning space and its physical properties, like for example electrical conductivity, depends first of all on type of the used collecting electrode 2 and the production technology. In other not represented examples of embodiment may be as a substrate 4 used also electrically conducting materials, for example a fabric with an electrostatic surface finish, a metal foil, etc. Upon application of special type of collecting electrode 2, known e.g. from the CZ PV 2007-727 the substrate 4, on the contrary, is not used at all, and the produced nanofibres are deposited directly on surface of the collecting electrode 2, from where they are after then removed.

In lower section of the spinning chamber 1 there is arranged the tank 5 of polymer matrix 51 formed in the represented example of embodiment of an opened vessel, while the polymer matrix 51 is the polymer solution in a liquid state. In further not represented examples of embodiment the principle of the invention may also be used at electrostatic spinning of melts of polymer, to which further corresponds variations in construction of the tank 5 and a not represented means for keeping the melt in liquid state.

In vicinity of the tank 5 there is mounted the spinning electrode containing the spinning element 6, connected to opposite pole of the source 3 of high direct voltage than the collecting electrode 2. The spinning element 6 is displaceable in adjustable intervals between its applying position, in which it is distanced from the collecting electrode 2, and the polymer matrix 51 is applied on it, and its spinning position in which it is, on the contrary, approached to the collecting electrode 2, so that between it and the collecting electrode 2 the electrostatic spinning field is induced, which performs the spinning of the polymer matrix 51 being applied on surface of the spinning element 6. Due to the fact, that the principle of the invention depends in no way on a shape and principle of the spinning electrode or its spinning elements 6, it is without any further changes applicable for all known structures of spinning electrodes, formed e.g. according to the CZ PV 2006-545 or CZ PV 2007-485 of a moveable wires, according to the CZ patent 294 274 of a rotating cylindrical body or e.g. according to the US 2005067732 by a nozzle or a group of nozzles. In the same way is the principle of the invention not limited anyhow by polarity of voltage brought to the collecting electrode 2 and the spinning electrode or to its spinning elements 6, as well as through grounding of some of them.

In a space above the tank 5 of polymer matrix 51 outside the trajectory of the spinning element 6 there is arranged an electrical device 7, which is in the represented example of embodiment a lighting element. Electrical device 7 is connected to the secondary winding 82 of a transformer 8, which is insulated for high voltage, while the primary winding 81 of the transformer 8 is via the overvoltage protection 9 connected to the source 10 of low alternating voltage. Suitable source 10 of low alternating voltage may be, especially thanks to its availability and long-term constant output, e.g. the public distribution network. Transformer 8 separates by its structure and function in galvanic manner the source of low alternating voltage 10 from all elements in the spinning space, to which it is supplied, or on which thanks to electric spinning field between the collecting electrode 2 and spinning element 6 a high direct voltage is induced, nevertheless at the same time it transfers alternating voltage, possibly other time change of voltage, from the source 10 of low alternating voltage into the electric device 7. Once the low alternating voltage is supplied to the primary winding 81 of the transformer 8, in its vicinity magnetic field with alternating flow of induction is induced, which is enclosed in the core 83 of transformer 8, and whose time change induces in the secondary winding 82 of transformer 8 a low alternating electric voltage. This voltage energizes after then the electric device 7 and its value is given by a ratio of number of windings of secondary winding 82 to the number of windings of primary winding 81 and value of voltage supplied into the primary winding 81 of the transformer 8. Utilising an adequately dimensioned transformer 8, it is possible to obtain on its secondary winding 82 nearly any value of alternating voltage required for supplying of electrical device 7, usually this value varies within the range of 1 to 230V, exceptionally up to 1000V, according to the particular type of electric device 7, or the method of connection of several electrical devices 7.

A lighting element is only the simplest electrical device 7, which may be energized in the spinning space upon utilisation of the transformer 8. Utilisation of more complex measuring or evaluating devices nevertheless usually requires, besides the input voltage provided by the transformer 8, also leading out of the data acquired by them outside the spinning space for further processing, usually in a form of pulses of a low electric voltage up to 50V.

The FIG. 2 represents the device for production of nanofibres through electrostatic spinning, in whose spinning space there is positioned and by means of the transformer 8 energized the electrical device 7, which is in this example of embodiment the measuring device for monitoring of concentration of solvent vapours, which is a component of the polymer matrix 51, being subject to spinning in the spinning space. Increased concentration of these vapours in extreme cases may lead to inflammation or even to explosion. Output channel of the measuring device is connected to primary winding 111 of an output transformer 11, to whose secondary winding 112 is further connected the device 12 for data processing, which is positioned outside the spinning chamber 1. Output data from the measuring device are in the form of pulses of low voltage transferred by means of the output transformer 11 into the device 12 for data processing for evaluation and/or storage and/or displaying and/or modification. The ratio of windings of the primary winding 111 and the secondary winding 112 of the output transformer 11 may be at the same time selected so that the output of the measuring device is amplified.

Between the secondary winding 112 of the output transformer 11 and the device 12 for data processing is with advantage inserted the not represented overvoltage protection, and possibly also the device for modification of output electric pulses for the purpose of their easier and quicker evaluation.

In other not represented examples of embodiment the output from the measuring devices is provided e.g. by optical means, possibly the data are evaluated, stored or displayed by the device 12 for processing of data positioned directly in the spinning space.

As the electrical device 7 in principle there may be used any known electrical devices with any value of supply voltage, which is achieved by a corresponding choice of ratio of number of windings of secondary winding 82 and primary winding 81 of the transformer 8 and/or value of alternating voltage supplied to the primary winding 81 of the transformer 8. Besides the lighting, measuring and evaluating elements, controlling systems or PC, it is possible to position into the spinning space also the heating resistor, in which the electric input of the supplied alternating voltage e.g. according to the equation P=U²/R is transformed to so called Joule-Lence heat, which is applicable for indirect heating of the spinning space, or of some elements of the device for production of nanofibres positioned in the spinning space. Increasing of temperature facilitates or even enables in some cases spinning of certain types of polymer matrices, for example of melts of polymers or solutions of polymers with high viscosity.

Another possibility of electrical device 7 positioned in the spinning space is an active element, which performs on basis of electrical voltage pulses other than the harmonic alternating voltage, supplied from a source of controlling electrical voltage pulses, the mechanical motion or it transfers the mechanical motion to other elements. Such active element is for example the drive of active element to ensure circulation of polymer matrix 51 in the tank 5, etc., while utilisation of these active elements has the highest effect in a case when they are combined with other electrical devices 7 positioned in the spinning space, e.g. the measuring elements with which they cooperate.

### LIST OF REFERENTIAL MARKINGS

1 spinning chamber
2 collecting electrode
3 source of high direct voltage
4 substrate
5 tank
51 polymer matrix
6 spinning element
7 electrical device
8 transformer
81 primary transformer winding
82 secondary transformer winding
83 transformer core
9 overvoltage protection
10 source of low alternating voltage
11 output transformer
111 primary winding of output transformer
112 secondary winding of output transformer
12 device for data processing

1. The device for production of nanofibres through electrostatic spinning of polymer matrix in a spinning space, in which against each other there is positioned a collecting electrode and a spinning electrode, between which an electric field of high intensity is induced, while the device includes at least one electrical device connected with a device for generating and/or evaluating of electric voltage pulses, wherein the electrical device is arranged in the spinning space in the electric field of high intensity, and is connected to one winding of a transformer, which is insulated for high voltage, while the transformer is arranged outside the electric field, and the second winding of transformer is connected to the device for generating and/or evaluating of electric voltage pulses positioned outside the spinning space.

2. The device according to claim 1, wherein the electrical device is connected to secondary winding of the transformer, which is insulated for high voltage, while the primary winding of the transformer is connected to the source of alternating voltage positioned outside the spinning space.

3. The device according to claim 1, wherein the electrical device is connected to the primary winding of the output transformer insulated for high voltage, while the secondary winding of the output transformer is connected to the device for data processing positioned outside the spinning space.

4. The device according to claim 2, wherein the source of alternating voltage is the public distribution network.

5. The device according to claim 1, wherein the electrical device is a lighting element.

6. The device according to claim 1, wherein the electrical device is a measuring element.

7. The device according to claim 1, wherein the electrical device is a evaluating element.

8. The device according to claim 1, wherein the electrical device is a controlling system.

9. The device according to claim 1, wherein the electrical device is a drive of mechanical element positioned in the spinning space.

10. The device according to claim 1, wherein the electrical device is a heat resistor.
